(19) United States
(12) Patent Application Publication
(10) Pub. No.: US 2010/0122434 A1
(43) Pub. Date: May 20, 2010

(54) Advertising Device Used in a Hinge Assembly

(76) Inventor: Chao-Chi Lin, Taichung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/273,603

(22) Filed: Nov. 19, 2008

(51) Int. Cl. E05D 5/10; G09F 19/00

(52) U.S. Cl. 16/386; 40/1

(57) ABSTRACT

An advertising device which is adapted to be implemented in a hinge assembly for a portable electronic device includes a display unit having a displaying surface on which an advertising mark is adapted to be presented and an engaging surface which receives a pintle of the hinge assembly. Further, a connector is mounted between the engaging surface and the pintle and the connector inhibits the display unit pivoting relative to the pintle so that the advertising mark on the display unit is remained in an upright position.

### BACKGROUND OF THE INVENTION

1. Field of the Invention

The present invention relates to an advertising device, in particular, to an advertising device which is adapted to be implemented in a hinge assembly for a portable electronic device.

2. Description of the Related Art

There have been many different prior arts as to a hinge assembly which is adapted to be implemented in a portable electronic device. One of the examples is a Taiwan patent which Pat. No. is M287031. Nevertheless, it seems that none of these prior arts teach a hinge assembly that is intended to accomplish an advertising effect. In fact, it should be appreciated how important a product image is related to sales and that customers nowadays don't just think utility is the only buying criteria.

The present invention is, therefore, intended to obviate or at least alleviate the problems encountered in the prior art.

### SUMMARY OF THE INVENTION

According to the present invention, an advertising device which is adapted to be implemented in a hinge assembly for a portable electronic device includes a display unit having a displaying surface on which an advertising mark is adapted to be presented and an engaging surface which receives a pintle of the hinge assembly. Further, a connector is mounted between the engaging surface and the pintle and the connector inhibits the display unit pivoting relative to the pintle so that the advertising mark on the display unit is remained in an upright position.

In one embodiment, the connector includes two legs which are spaced from each other, and the engaging surface includes a cavity which receives an end of the pintle and two slots which is connected to and is in communication with the cavity and which receives the two legs respectively. Therefore, the two legs are adapted to abut two sides of the pintle respectively and then inhibit the display unit from rotation relative to the pintle.

In another embodiment, the connector includes a through hole through which the pintle is inserted and a peripheral edge which defines a first engaging portion and a second engaging portion having an inset. Further, the engaging surface includes a cavity which receives an end of the pintle, an engaging protrusion which is received by the first engaging portion of the connector and an engaging hook having a barb which is received by the inset of the connector. As such, the display unit is then inhibited from rotation relative to the pintle.

In another embodiment, the connector includes a shaft, and the engaging surface includes a cavity which receives an end of the pintle and a hole which is connected to and is in communication with the cavity and which receives the shaft. Therefore, the shaft is adapted to abut a side of the pintle and then inhibit the display unit from rotation relative to the pintle.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

### BRIEF DESCRIPTION OF THE DRAWINGS

FIG. 1 is a perspective view of a hinge assembly with an advertising device in accordance with a first embodiment of the present invention.

FIG. 2 is an exploded perspective view of the advertising device shown in FIG. 1.

FIG. 3 is an exploded perspective view of FIG. 1.

FIG. 4 is a cross-sectional view of line 4-4 in FIG. 1.

FIG. 5 is a side view of FIG. 1.

FIG. 6 is another side view of FIG. 1 and illustrating operation of the hinge assembly.

FIG. 7 is a perspective view showing the hinge assembly and the advertising device are implemented in a portable electronic device, with the portable electronic device shown in phantom.

FIG. 8 is a perspective view of a hinge assembly with an advertising device in accordance with a second embodiment of the present invention.

FIG. 9 is an exploded perspective view of the advertising device shown in FIG. 8.

FIG. 10 is a cross-sectional view of line 10-10 in FIG. 8.

FIG. 11 is a cross-sectional view of line 11-11 in FIG. 10.

FIG. 12 is a perspective view of a hinge assembly with an advertising device in accordance with a third embodiment of the present invention.

FIG. 13 is an exploded perspective view of the advertising device shown in FIG. 12, and with a display unit of the advertising device partially in section.

FIG. 14 is a cross sectional view of the hinge assembly and the advertising device.

### DETAILED DESCRIPTION OF THE PREFERRED EMBODIMENT

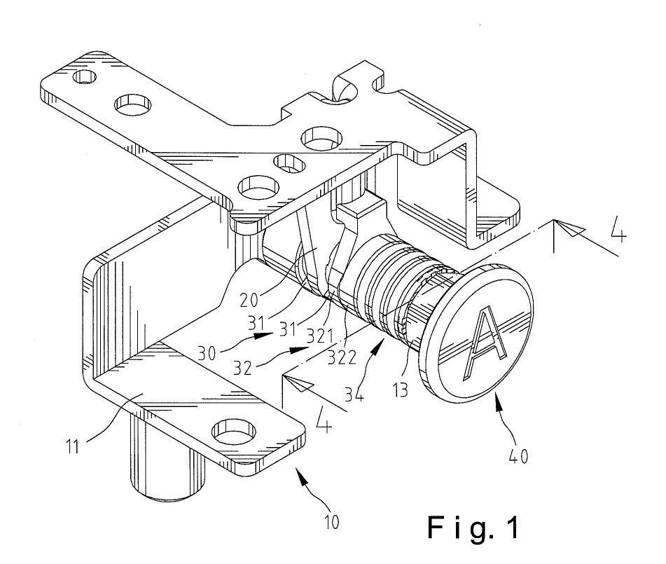

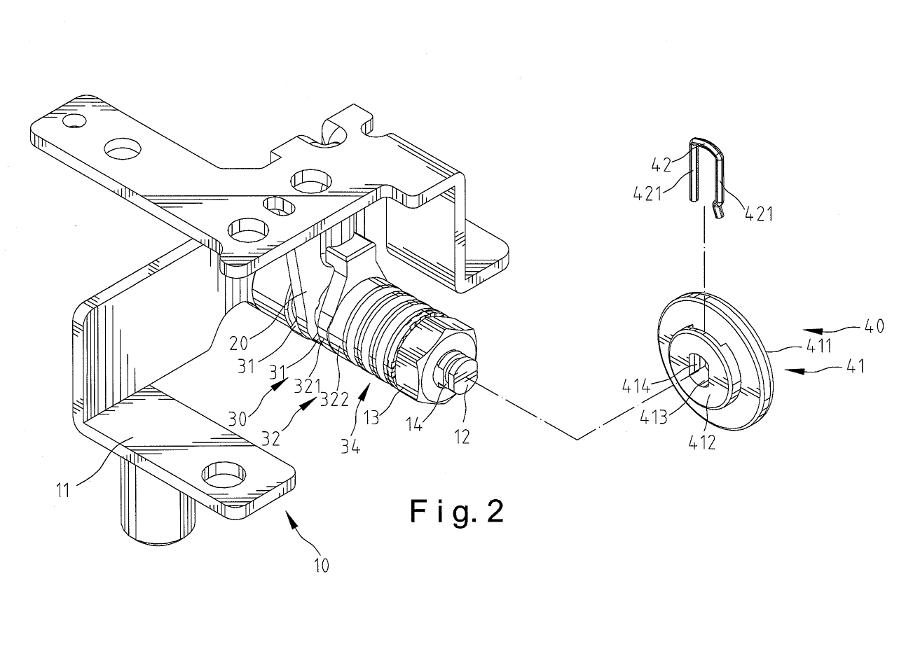

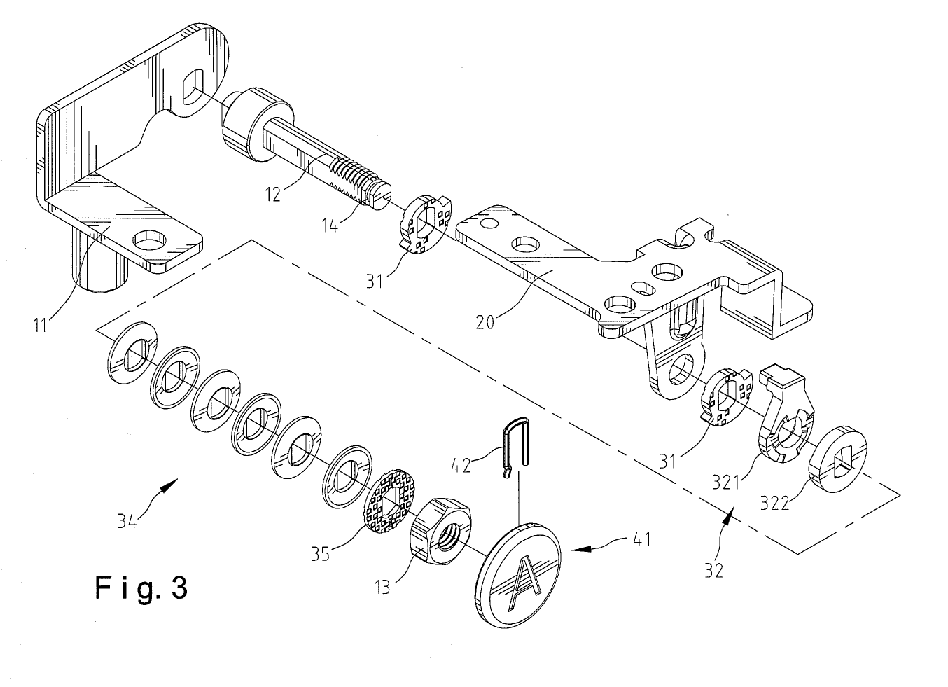

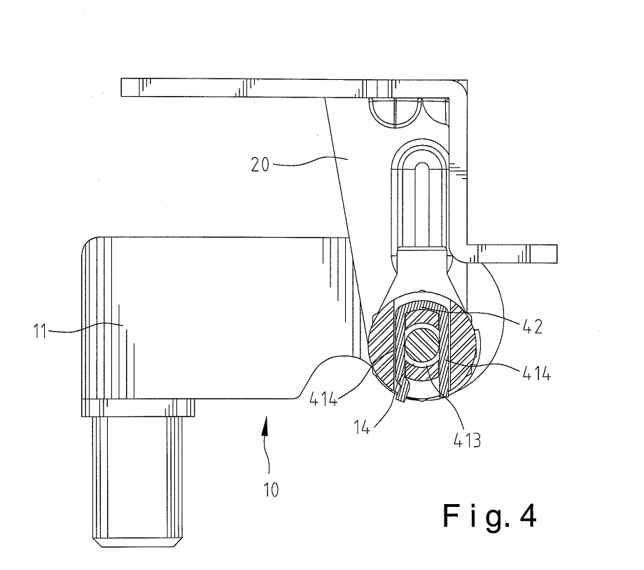

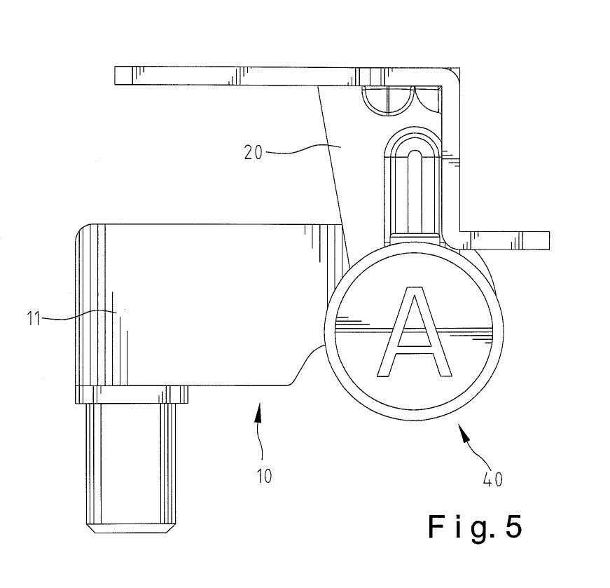

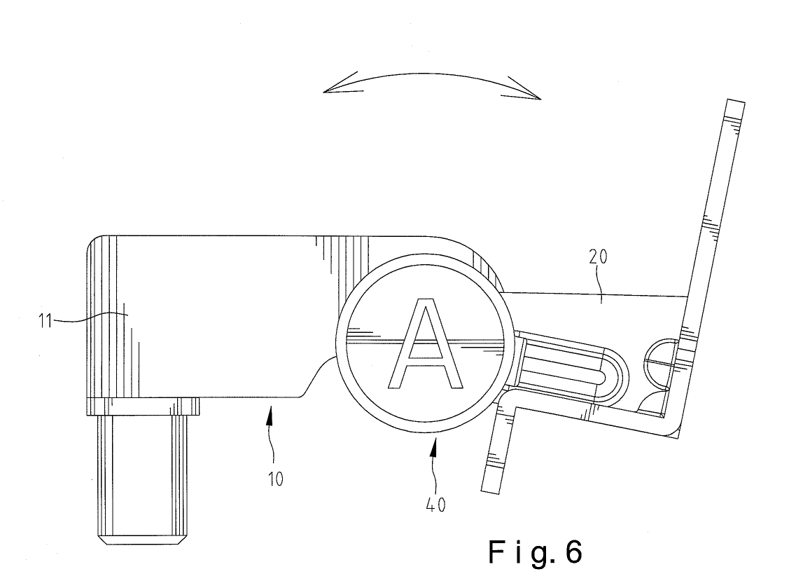

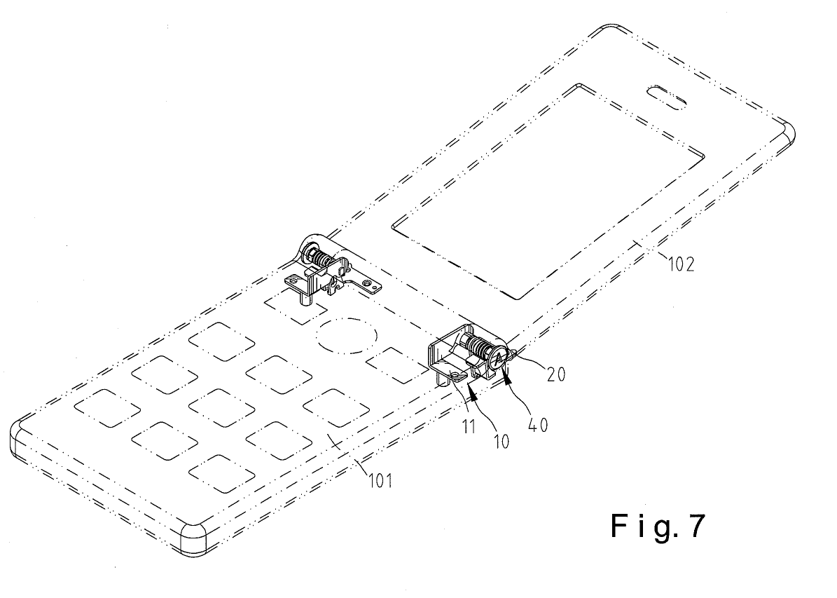

FIGS. 1 through 7 show an advertising device 40 which is adapted to be implemented in a hinge assembly 10 for a portable electronic device which includes a base 101 and a cover 102. Then, the base 101 is pivotal relative to the cover 102. Preferably, the hinge assembly 10 includes a pintle 12, a first coupling member 11 which is connected to the pintle 12 and is connectable to a one of a base 101 and a cover 102, and a second coupling member 20 which is connected to the pintle 12 and is connectable to another of the base 101 and the cover 102. Preferably, the hinge assembly 10 also includes a positioning member 31 which is operable to move to a position that the cover 102 is inhibited from further advancement relative to the base 101. Preferably, the hinge assembly 10 further includes a cam device 32 for retaining the cover 102 at a predetermined angular position relative to the base 101, and the cam device 32 includes a first cam member 321 and a second cam member 322 disposed in juxtapose and coacting with the first cam member 321 The first cam member 321 is operable to pivot relative to the second cam member 322 such that the relative pivotal moment therebetween results a relative axial movement between the first and second cam members 321 and 322. Preferably, the hinge assembly 10 further includes a biasing device 40 having a plurality of discs (not numbered) through which the pintle 12 is inserted and each has a resilient characteristic. Preferably, the biasing device 40 is disposed between the cam device 32 and an end cap 13 and biasably moved by the cam device 32 and each of the plurality of discs are adapted to be depressed.

The advertising device 40 includes a display unit 41 having a displaying surface 411 on which an advertising mark “A” is adapted to be presented and an engaging surface 412 which connects the display unit 41 to the pintle 12. Preferably, the engaging surface 412 includes a cavity 413 which receives an end of the pintle 12 such that the display unit 41 is connected to the pintle 12. Additionally, the engaging surface 412 includes two slots 414 which is connected to and is in communication with the cavity 413 and which receives a connector 42. Preferably, the connector 42 includes two legs 421 which are spaced from each other and are received in the slots 414 respectively. Therefore, the two legs 421 are adapted to abut two opposite sides of the pintle 12 respectively and then inhibit the display unit 41 from rotation relative to the pintle 12 so that the advertising mark “A” on the display unit 41 is remained in an upright position.

Preferably, the connector 42 is made of a metal wire that has a resilient characteristic so that the two legs 421 resiliently clutch the pintle 12.

Preferably, the pintle 12 includes a groove 14 which extends along a peripheral edge thereof circumferentially and receives the two legs 421.

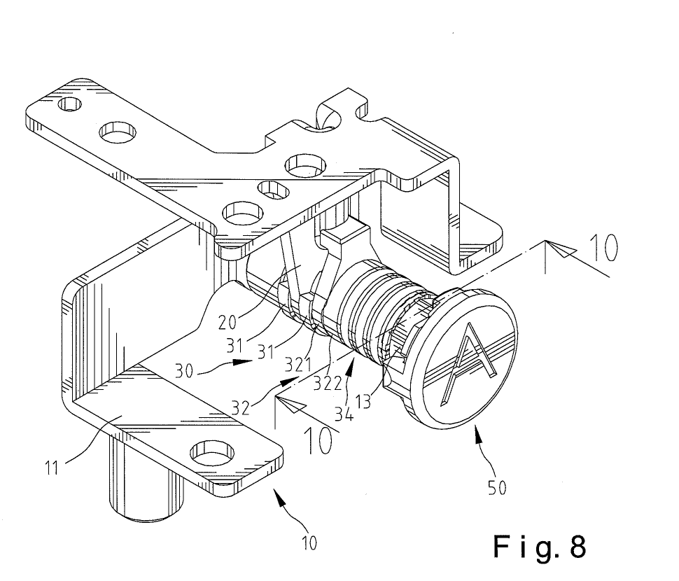

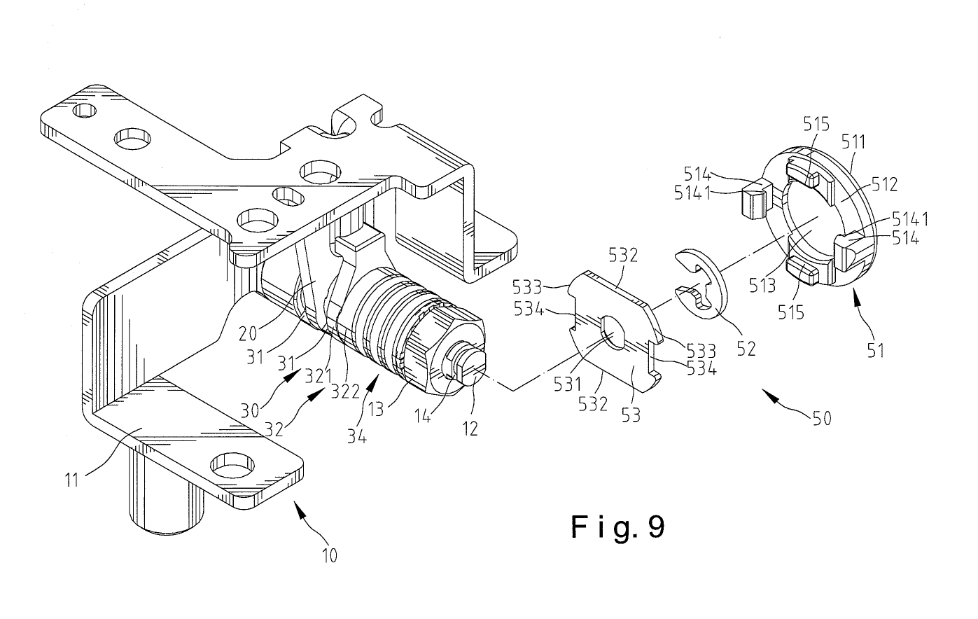

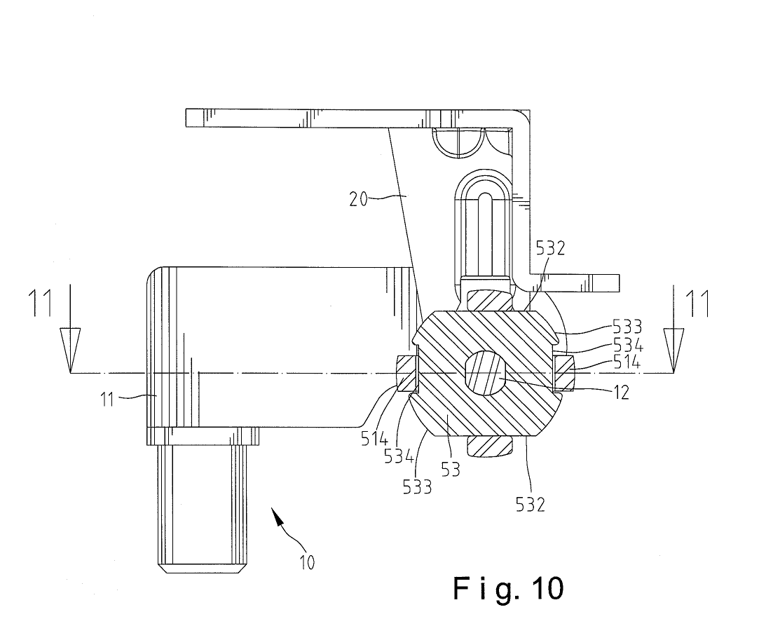

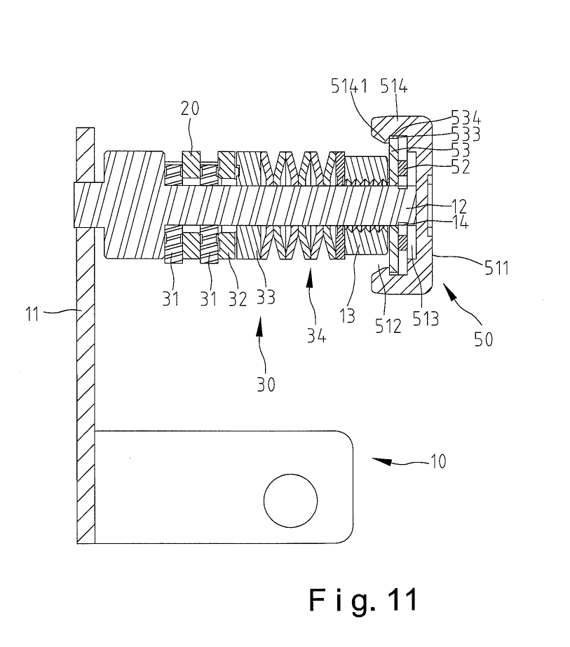

Referring to FIGS. 8 through 11, an advertising device 50 in accordance with a second embodiment of the present invention includes a connector 53 having a through hole 531 through which the pintle 12 is inserted and a peripheral edge which defines a first engaging portion 532 and a second engaging portion 533 having an inset 534. Further, a display unit 51 includes a displaying surface 511 on which an advertising mark “A” is adapted to be presented and an engaging surface 512 which connects the display unit 51 to the pintle 12. Preferably, the engaging surface 512 includes a cavity 513 which receives an end of the pintle 12 such that the display unit 51 is connected to the pintle 12. Additionally, the engaging surface 512 includes an engaging protrusion 515 which is received by the first engaging portion 532 of the connector 53 and an engaging hook 514 having a barb 5141 which is received by the inset 534 of the connector 53. As such, the display unit 51 is then inhibited from rotation relative to the pintle 12.

Preferably, the advertising device 50 further includes a clipping member 52 for securely holding the connector 53 on the pintle 12. Preferably, the clipping member 52 is disposed outside the connector 53.

The clipping member 52 has two opposite ends abutting two sides of the pintle 12 respectively and is received in the groove 14.

Preferably, the clipping member 52 is made of a metal wire that has a resilient characteristic so that the two opposite ends resiliently clutch the pintle 12.

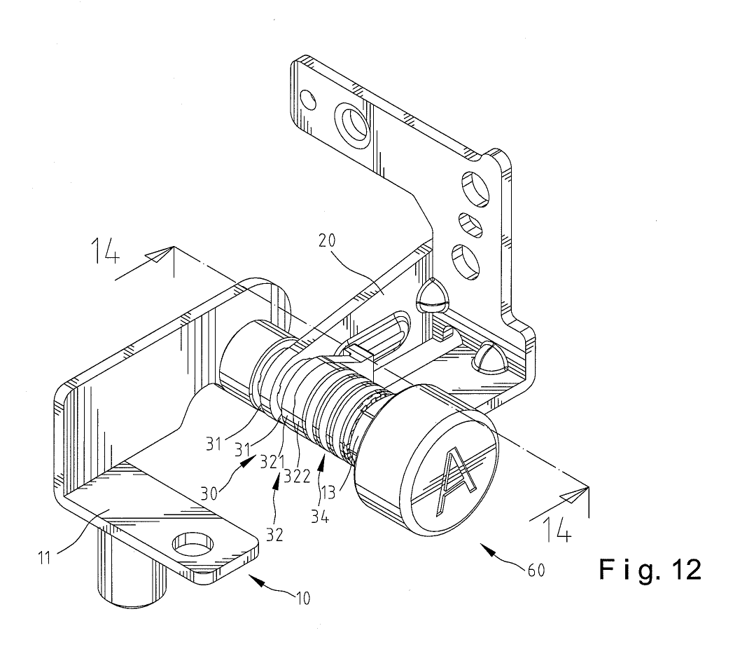

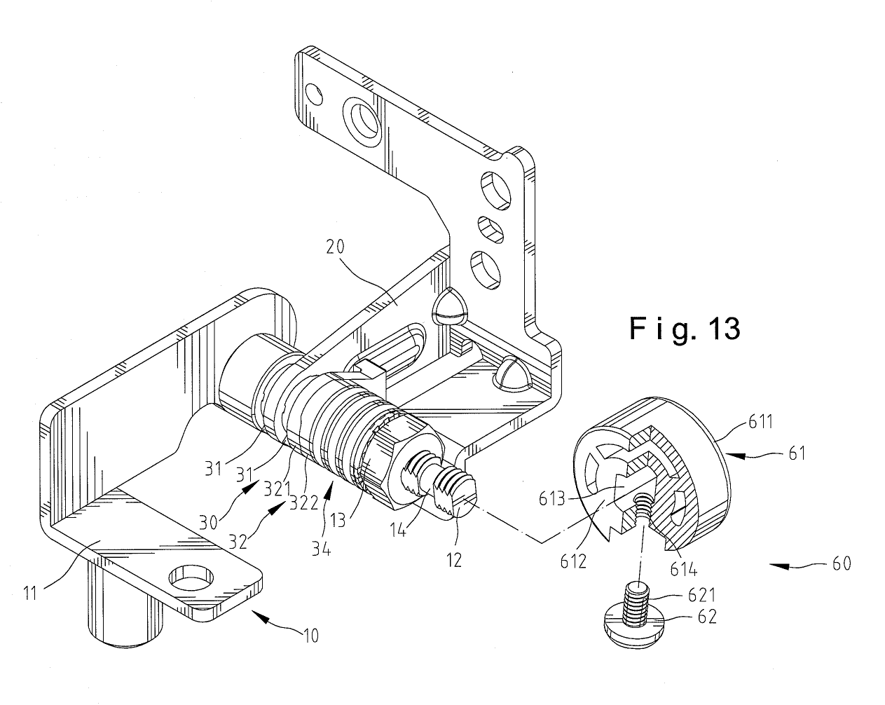

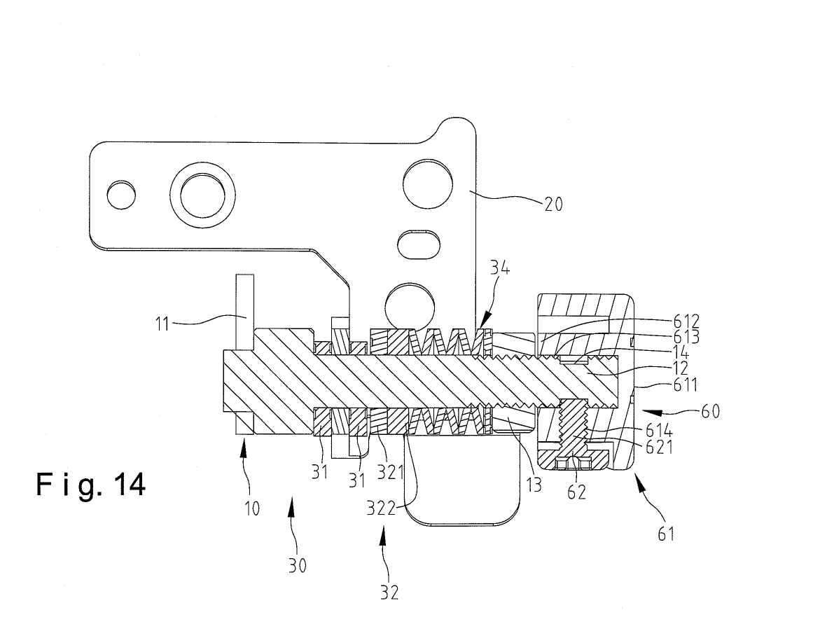

Referring to FIGS. 12 through 14, an advertising device 60 in accordance with a third embodiment of the present invention includes a connector 62 having a shaft 621. Further, a display unit 61 includes a displaying surface 611 on which an advertising mark “A” is adapted to be presented and an engaging surface 612 which connects the display unit 61 to the pintle 12. Preferably, the engaging surface 612 includes a cavity 613 which receives an end of the pintle 12 such that the display unit 61 is connected to the pintle 12. Additionally, the engaging surface 612 includes a hole 614 which is connected to the cavity 613 and which receives the shaft 621 so that the pintle 12 has a side abutted by the shaft 621 and as such the display unit 61 is then inhibited from rotation relative to the pintle.

While the specific embodiments have been illustrated and described, numerous modifications come to mind without significantly departing from the spirit of invention and the scope of invention is only limited by the scope of accompanying claims.

What is claimed is:

1. An advertising device which is adapted to be implemented in a hinge assembly for a portable electronic device, with the hinge assembly including a pintle and a first coupling member and a second coupling member both connected to the pintle, with the first coupling member connectable to a one of a base and a cover of the portable electronic device, with the second coupling member connectable to another of the base and the cover, and with the cover pivotal relative to the base comprising:
a display unit including a displaying surface on which an advertising mark is adapted to be presented and an engaging surface receiving an end of the pintle; and
a connector mounted between the engaging surface and the pintle; and
wherein the connector inhibits the display unit pivoting relative to the pintle so that the advertising mark on the display unit is remained in an upright position.

2. The advertising device as claimed in claim 1 wherein the connector includes two legs spaced from each other, and wherein the engaging surface includes a cavity and two slots connected to the cavity, with the cavity receiving the end of the pintle, and with the two slots receiving the two legs respectively, and wherein the pintle has two sides abutted by the two legs respectively such that the pintle is clutched by the two legs.

3. The advertising device as claimed in claim 2 wherein the connector is made of a metal wire that has a resilient characteristic so that the two legs resiliently clutch the pintle.

4. The advertising device as claimed in claim 1 wherein the connector includes a through hole through which the end of the pintle is inserted and a peripheral edge defining a first engaging portion and a second engaging portion having an inset, and wherein the engaging surface includes a cavity receiving the end of the pintle, an engaging protrusion received by the first engaging portion of the connector and an engaging hook having a barb received by the inset of the connector.

5. The advertising device as claimed in claim 4 further comprising a clipping member having two opposite ends, and wherein the pintle has two side abutted by the two opposite ends respectively, and wherein clipping member is disposed outside the connector such that the connector is held securely on the pintle by the clipping member.

6. The advertising device as claimed in claim 5 wherein clipping member is made of a metal wire that has a resilient characteristic so that the two opposite ends resiliently clutch the pintle.

7. The advertising device as claimed in claim 1 wherein the connector includes a shaft, and wherein the engaging surface includes a cavity and a hole connected to the cavity, with the cavity receiving the end of the pintle, and with the hole receiving the shaft, and wherein the pintle has a side abutted by the shaft.

8. A hinge assembly for a portable electronic device which includes a base and a cover, with the cover pivotal relative to the base comprising:
a pintle;
a first coupling member connected to the pintle and connectable to a one of a base and a cover;
a second coupling member connected to the pintle and connectable to another of the base and the cover;
an advertising device including a display unit having a displaying surface on which an advertising mark is adapted to be presented and an engaging surface receiving an end of the pintle, and a connector mounted between the engaging surface and the pintle; and
wherein the connector inhibits the display unit pivoting relative to the pintle so that the advertising mark on the display unit is remained in an upright position.

9. The hinge assembly as claimed in claim 8 further comprising a positioning member which is operable to move to a position that the cover is inhibited from further advancement relative to the base.

10. The hinge assembly as claimed in claim 9 further comprising a cam device for retaining the cover at an predetermined angular position relative to the base, and wherein the cam device includes a first cam member and a second cam member disposed in juxtapose and coacting with the first cam member, and with the first cam member operable to pivot relative to the second cam member such that the relative pivotal moment therebetween results a relative axial movement between the first and second cam members.

11. The hinge assembly as claimed in claim 10 further comprising a biasing device including a plurality of discs through which the pintle is inserted and each has a resilient characteristic, and wherein the biasing device is biasably moved by the cam device and each of the plurality of discs are adapted to be depressed.

12. The hinge assembly as claimed in claim 8 wherein the connector includes two legs spaced from each other, and wherein the engaging surface includes a cavity and two slots connected to the cavity, with the cavity receiving the end of the pintle, and with the two slots receiving the two legs respectively, and wherein the pintle has two sides abutted by the two legs respectively such that the pintle is clutched by the two legs.

13. The hinge assembly as claimed in claim 12 wherein the connector is made of a metal wire that has a resilient characteristic so that the two legs resiliently clutch the pintle.

14. The hinge assembly as claimed in claim 8 wherein the connector includes a through hole through which the end of the pintle is inserted and a peripheral edge defining a first engaging portion and a second engaging portion having an inset, and wherein the engaging surface includes a cavity receiving the end of the pintle, an engaging protrusion received by the first engaging portion of the connector and an engaging hook having a barb received by the inset of the connector.

15. The hinge assembly as claimed in claim 14 further comprising a clipping member having two opposite ends, and wherein the pintle has two side abutted by the two opposite ends respectively, and wherein clipping member is disposed outside the connector such that the connector is held securely on the pintle by the clipping member.

16. The hinge assembly as claimed in claim 15 wherein clipping member is made of a metal wire that has a resilient characteristic so that the clipping member resiliently clutch the pintle.

17. The hinge assembly as claimed in claim 8 wherein the connector includes a shaft, and wherein the engaging surface includes a cavity and a hole connected to the cavity, with the cavity receiving the end of the pintle, and with the hole receiving the shaft, and wherein the pintle has a side abutted by the shaft.

18. The hinge assembly as claimed in claim 11 wherein the connector includes two legs spaced from each other, and wherein the engaging surface includes a cavity and two slots connected to the cavity, with the cavity receiving the end of the pintle, and with the two slots receiving the two legs respectively, and wherein the pintle has two sides abutted by the two legs respectively such that the pintle is clutched by the two legs.

19. The hinge assembly as claimed in claim 11 wherein the connector includes a through hole through which the end of the pintle is inserted and a peripheral edge defining a first engaging portion and a second engaging portion having an inset, and wherein the engaging surface includes a cavity receiving the end of the pintle, an engaging protrusion received by the first engaging portion of the connector and an engaging hook having a barb received by the inset of the connector.

20. The hinge assembly as claimed in claim 11 wherein the connector includes a shaft, and wherein the engaging surface includes a cavity and a hole connected to the cavity, with the cavity receiving the end of the pintle, and with the hole receiving the shaft, and wherein the pintle has a side abutted by the shaft.
